(19) United States
(12) Patent Application Publication
(10) Pub. No.: US 2021/0056493 A1
(43) Pub. Date: Feb. 25, 2021

(54) DEVICE FOR CREATING AND MANAGING ITINERARIES

(71) Applicant: Atos Integration, Bezons (FR)

(72) Inventors: Christophe FOURNIER, Fenouillet (FR); Hubert LESPINASSE, Tournefeuille (FR); Christophe AILLERES, Labastide Beauvoir (FR)

(21) Appl. No.: 16/999,209

(22) Filed: Aug. 21, 2020

(30) Foreign Application Priority Data
Aug. 23, 2019 (FR) 1909382

(51) Int. Cl. G06Q 10/06; G06F 16/29; H04W 4/021

(52) U.S. Cl. CPC G06Q 10/063116; H04W 4/021; G06F 16/29; G06Q 10/063118

(57) ABSTRACT

The present invention relates to a system for managing itineraries for a group of people, comprising a module for communicating data in real time, able to send and receive data from at least one other communication module, the data comprising for example information relating to planned or unplanned events, a database comprising vectorial and/or georeferenced geographical data, and non-georeferenced data, the data comprising, for example, information relating to events, the topography surrounding the terminal and/or the group, information relating to the group, a module for calculating an itinerary to be carried out, the calculation module calculating said itinerary based on information transmitted by the reception module, the module for calculating an itinerary configured to calculate the optimal itinerary, according to configurable decision criteria stored in memory, based on data stored in a database.

### TECHNICAL FIELD OF THE INVENTION

The present invention generally relates to the field of itinerary management devices, in particular for patrols.

### PRIOR ART

The course of an ordinary day for an individual of a security or preventative security operation is planned manually and day by day, taking into account the life of the city and information including the current events of the town, for example a planned protest or a sports meet. Each item of information received corresponds to an action for the security and preventative security forces in response to this information. Itineraries are thus provided to patrols each morning for the day, in particular using a map on which an itinerary is superimposed.

Optimization of an itinerary using a GPS device, for example the “mass-market” GPS device which superimposes the itinerary onto a map and transmits the information to the driver of a car, is known from the prior art. There also are systems for sending the same itineraries to a fleet of heavy trucks forming a group, in order to give them the same itinerary.

For example, application US20170323249 describes a system making it possible to dynamically and optimally sequence route itineraries for a vehicle based on historic conditions and real-time traffic, and to anticipate the traffic conditions expected along the dynamically-generated itinerary. The linking of itineraries is based on a set of predefined constraints, for example distance, time, time based on traffic, or any other objective cost function. This system may be implemented in a fleet of vehicles comprising one or more vehicles with one or more deliveries, or without deliveries. An optimization server obtains data in real time, according to the traffic history and/or according to the anticipated traffic, the weather, hazards and avoidance zones on avoidance zones on road segments in order to generate an itinerary, while complying with the parameters and constraints defined by a machine learning automatic process, an artificial intelligence program or a human administrator. The platform can be coupled to sensors placed on the roads, for example a speed camera or a camera, and to sensors placed in the vehicles, for example a GPS system or an onboard diagnostics sensor.

In addition, some of these GPS devices integrate points of interest into their data, the driver thus being able to configure their GPS device to ask the itinerary calculating software to take these points of interest as points to be incorporated into the itinerary to be calculated.

However, currently there is a lack of a device which enables the planning of actions for humans assigned to security or preventative security operations, in real time, with multiple constraints and points of interest, based on various items of data.

### DISCLOSURE OF THE INVENTION

The object of the present invention therefore is to propose a device for creating and managing itineraries, for patrols or people assigned to security or preventative security operations, making it possible to overcome at least some of the disadvantages of the prior art.

This aim is achieved by a device for managing itineraries for a group of people, comprising program modules executable on one or more processing hardware components such as a microprocessor, the device being characterized in that it comprises:
A module for communicating data in real time, able to send and receive data from at least one other communication module, the data comprising for example information relating to planned or unplanned events,
At least one database comprising vectorial and/or georeferenced geographical data, and non-georeferenced data,
a module for calculating an itinerary to be carried out, the calculation module calculating said itinerary based on information transmitted by the reception module, the module for calculating an itinerary implementing at least one artificial intelligence algorithm having an automatic learning architecture configured to calculate the optimal itinerary, according to configurable decision criteria stored in memory, based on data stored in a database, said artificial intelligence algorithm being based on data, preferentially ranked data, from the database, such as stored public and private data comprising itineraries, events, and past situations, and/or present and past weather or news data.

According to one particular feature, the database comprises vectorial and/or georeferenced geographical data, and non-georeferenced data, the data comprising information relating to events, the topography surrounding at least one terminal used by a member of the group and/or the group, or information relating to the group.

According to one particular feature, the calculation module comprises an implementing event detection sub-module configured to be able to access, via the Internet, different networks, in particular social networks, or other sources of public or private information to detect planned and unplanned events, to collect data from the detected events, and to record them in the database of the device, for example by extraction and analysis of public or private data such as those originating from social networks or messages.

According to one particular feature, said calculation module is configured to automatically rank said detected events according to criteria defined in relation to a mission of the group of people.

According to another particular feature, the configurable decision criteria make it possible to add constraints for the calculation of the itinerary, for example preferences, passing points or checkpoints, information originating from a database relating to the personnel and in particular the state of each member of the personnel constituting, or who may constitute, the group, or complementary orders originating from a hierarchical level, for example bans.

According to another particular feature, the data received and sent by the device is encrypted, the device further comprising an encryption and decryption module to decrypt the data received and to encrypt the data sent.

According to another particular feature, the calculation module provides the itinerary in the form of a graphical command or a map, comprising colored dots connected to one another, which indicate on the graphic or the map, by means of symbols, particular places or events.

According to another particular feature, the calculation module is configured to send and order the display of different types of information and mission orders.

According to another particular feature, the data used by the calculation module is extracted from private databases containing same, and selected from private data such as the past routes of patrols in order to determine the duration of the patrol based on the perimeter to be covered, past events noted and recorded in the communication system, sensitive sites stored in memory and located within the patrol's perimeter, the relevance of the patrol members based on data from the personnel database, the number of kilometers already covered by the personnel of the group provided by the terminal of at least one member of the group, the topography of the ground provided by vectorial geographical databases, and public data such as weather or for example the current state of planned or unpredicted events, this data being recovered by an interface connected to the Internet, or specific databases.

According to another particular feature, said detection sub-module is configured to perform textual and/or contextual analyses to detect planned and/or unplanned events.

According to another particular feature, the device for managing itineraries is part of an itinerary management system further comprising a communication terminal, preferably a mobile communication terminal carried by at least one user who is part of said group of people, the communication terminal comprising:
a module for communicating data in real time, able to send and receive data from at least one other communication module, the data comprising for example information relating to planned or unplanned events
a man-machine interface (MMI) application comprising a graphic display module for the itinerary calculated by the calculation module, configured to display on said communication terminal said itinerary and/or information received from the device,
At least one database comprising vectorial, georeferenced and/or non-georeferenced geographical data, the data comprising, for example, information relating to events, the topography surrounding at least one terminal used by a member of the group and/or the group, and data relating to the group;

According to another particular feature, the application of the terminal further comprises a module for the manual input of data or events, for example of unplanned events, by the user of the terminal, the communication terminal preferably being configured to send said data or event to the itinerary management device.

According to another particular feature, the terminal further comprises a module for calculating the position of said terminal, configured to calculate in real time the position of a user of the device via their terminal and, for example, locate them on their route or even orient a map relative to the position, orientation and/or movement of the user.

According to another particular feature, the module for calculating the position of said terminal is configured to send said position of the terminal to the itinerary management device, by sending data via the communication module of the terminal.

According to another particular feature, the graphic display module provides the itinerary in the form of a graphical command or a map, comprising colored dots or symbols, for example connected to one another, and indicating on the graphic or the map particular places or events.

According to another particular feature, the graphic display module is configured to display different types of information and mission orders.

According to another particular feature, each communication module comprises an encryption module configured to encrypt data to be sent via the communication module and to decrypt encrypted data received by the communication module.

According to another particular feature, the system further comprising a secure communication server configured to be a relay gateway between the itinerary management device and a plurality of communication terminals, the server comprising a communication module configured to send data of the calculated itinerary to a plurality of communication modules of a plurality of terminals, and an encryption and decryption module configured to encrypt data to be sent to the device and to the terminal and to decrypt encrypted data received from the device and from the terminal.

### BRIEF DESCRIPTION OF THE FIGURES

Other features, details and advantages of the invention will emerge from reading the following description, with reference to the appended figures, wherein:

FIG. 1 schematically shows the system according to certain embodiments,

FIG. 2 shows examples of displays of the application according to certain embodiments.

### DETAILED DESCRIPTION OF THE INVENTION

Numerous combinations can be contemplated without departing from the scope of the invention: the person skilled in the art will choose one or the other based on economic, ergonomic or size constraints or other constraints they have to comply with.

Generally, the present invention comprises a device for managing itineraries for a group of people, comprising program modules executable on one or more processing hardware components such as a microprocessor, the device being characterized in that it comprises:
A module for communicating data in real time, able to send and receive data from at least one other communication module, the data comprising for example information relating to planned or unplanned events,
At least one database comprising vectorial and/or georeferenced geographical data, and non-georeferenced data,
a module for calculating an itinerary to be carried out, the calculation module calculating said itinerary based on information transmitted by the reception module, the module for calculating an itinerary implementing at least one artificial intelligence algorithm having an automatic learning architecture configured to calculate the optimal itinerary, according to configurable decision criteria stored in memory, based on data stored in a database, said artificial intelligence algorithm being based on data, preferentially ranked data, from the database, such as stored public and private data comprising itineraries, events, and past situations, and/or present and past weather or news data.

Advantageously, the calculation of the itineraries by the calculation module is preferentially centralized in a management device, since it is very cumbersome to be held and operated by each portable communication terminal in a decentralized manner. The server performs the calculations of the routes based on the information received, then sends them to recipients, preferably at least one communication terminal.

One of the aims of the device is to merge a large amount of data together (geographical, contextual, graphical) in order to define the best possible route graph.

“Drone” is intended to mean any unoccupied aerial vehicle comprising a computer carried by the unoccupied aerial vehicle to control the flight of the unoccupied aerial vehicle, the drone being able to communicate with a remote communication server. The term “at least one artificial intelligence algorithm” is intended here to mean either artificial neural networks (generally trained on said ranked data) or statistical tools using said data (for example to find relevant “statistical sinks”).

In some embodiments, the database comprises vectorial and/or georeferenced geographical data, and non-georeferenced data, the data comprising information relating to events, the topography surrounding at least one terminal used by a member of the group and/or the group, or even information relating to the group.

It is understood that the device may comprise a single database or several databases. In the cases in which it comprises several databases, it may comprise a database of personnel and/or users of the system.

In some embodiments, the calculation module comprises an event detection sub-module configured to be able to access, via the Internet, different networks, in particular social networks, or other sources of public or private information to detect planned and unplanned events, to collect data from the detected events, and to record them in the database of the device, for example by extraction and analysis of public or private data such as those originating from social networks or messages.

In some embodiments, said artificial intelligence algorithm is configured to automatically rank said detected events according to criteria defined in relation to a mission of the group of people.

In some embodiments, the configurable decision criteria make it possible to add constraints for the calculation of the itinerary, for example preferences, passing points or checkpoints, information originating from a database relating to the personnel and in particular the state of each member of the personnel constituting, or who may constitute, the group, or complementary orders originating from a hierarchical level, for example bans.

The state of each member of the personnel may for example be a state among tired, relevant, beginner or any other state representing a decision factor for the choice of people to be incorporated in a given itinerary.

In some embodiments, the data received and sent by the device is encrypted, the device further comprising an encryption and decryption module to decrypt the data received and to encrypt the data sent.

In some embodiments, the calculation module provides the itinerary in the form of a graphical command or a map, comprising colored dots connected to one another and indicating on the graphic or the map, by means of symbols, particular places or events.

In some embodiments, the calculation module is configured to send and order the display of different types of information and mission orders.

In some embodiments, the data used by the calculation module is extracted from private databases containing same, and selected from private data such as the past routes of patrols in order to determine the duration of the patrol based on the perimeter to be covered, past events noted and recorded in the communication system, sensitive sites stored in memory and located within the patrol's perimeter, the relevance of the patrol members based on data from the personnel database, the number of kilometers already covered by the personnel of the group provided by the terminal of at least one member of the group, the topography of the ground provided by vectorial geographical databases, and public data such as weather or for example the current state of planned or unpredicted events, this data being recovered by an interface connected to the Internet, or specific databases.

In some embodiments, said detection sub-module is configured to perform textual and/or contextual analyses to detect planned and/or unplanned events.

In some embodiments, the device for managing itineraries is part of an itinerary management system further comprising a communication terminal, preferably a mobile communication terminal carried by at least one user who is part of said group of people, the communication terminal comprising:
a module for communicating data in real time, able to send and receive data from at least one other communication module, the data comprising for example information relating to planned or unplanned events
a man-machine interface (MMI) application comprising a graphic display module for the itinerary calculated by the calculation module, configured to display on said communication terminal said itinerary and/or information received from the device,
At least one database comprising vectorial and/or georeferenced geographical data, and non-georeferenced data, the data comprising, for example, information relating to events, the topography surrounding at least one terminal used by a member of the group and/or the group, and data relating to the group;

The terminal for example consists of a computer system integrating mobile applications from a mass-market device or a tablet, operating with a public or private communication system.

In some embodiments, the application of the terminal further comprises a module for the manual input of data or events, for example of unplanned events, by the user of the terminal, the communication terminal preferably being configured to send said data or event to the itinerary management device.

In some embodiments, the terminal further comprises a module for calculating the position of said terminal, configured to calculate in real time the position of a user of the device via their terminal and, for example, locate them on their route or even orient a map relative to the position, orientation and/or movement of the user.

In some embodiments, the module for calculating the position of said terminal is configured to send said position of the terminal to the itinerary management device, by sending data via the communication module of the terminal.

In some embodiments, the graphic display module provides the itinerary in the form of a graphical command or a map, comprising colored dots or symbols, for example connected to one another, which indicate on the graphic or the map particular places or events.

In some embodiments, the graphic display module is configured to display different types of information and mission orders.

In some embodiments, each communication module comprises an encryption module configured to encrypt data to be sent via the communication module and to decrypt encrypted data received by the communication module.

In some embodiments, the system further comprising a secure communication server configured to be a relay gateway between the itinerary management device and a plurality of communication terminals, the server comprising a communication module configured to send data of the calculated itinerary to a plurality of communication modules of a plurality of terminals, and an encryption and decryption module configured to encrypt data to be sent to the device and to the terminal and to decrypt encrypted data received from the device and from the terminal.

In some embodiments, the calculation module uses a vectorial geographical database (lines, polygons, etc.), as opposed to “raster” maps (images which cannot be readily utilized by algorithms).

In some embodiments, the device comprises georeferenced databases such as those comprising “Open Street Map” maps and those comprising reliefs: SRTM (Shuttle Radar Topography Mission) databases.

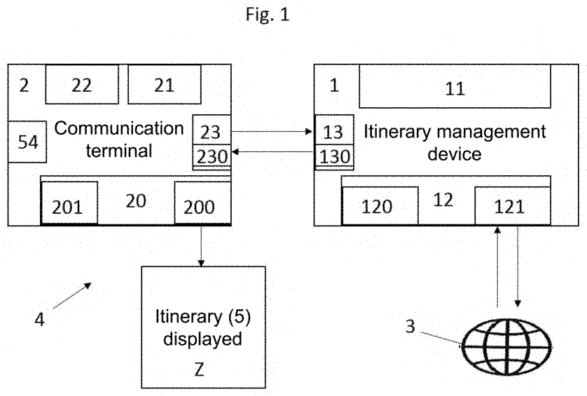

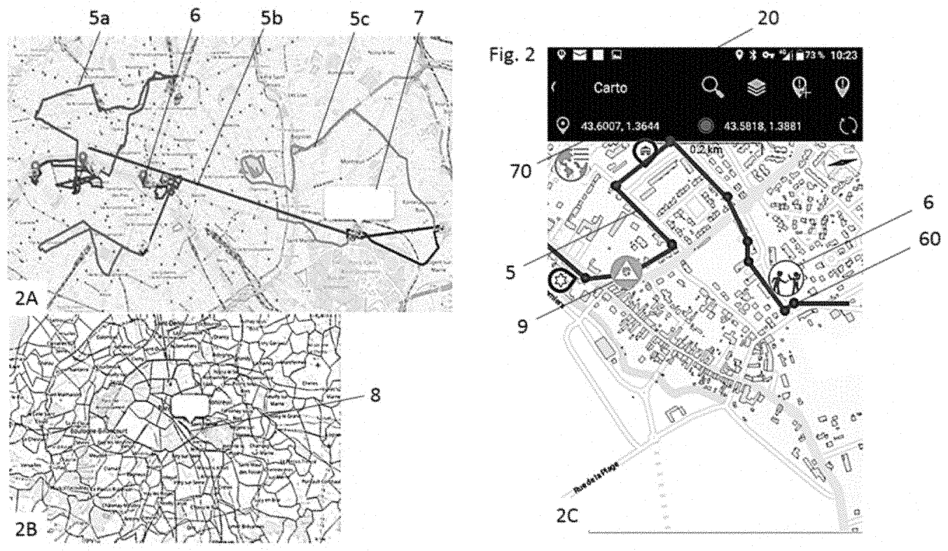

In some embodiments, the itinerary management system (4), for example illustrated by way of non-limiting example in FIG. 1, comprises an itinerary management device (1) in communication with a communication terminal (2). The device (1) comprises a database comprising, in a database (11) a plurality of items of information to be taken into account to create an optimized itinerary for a person or a group of people, for example soldiers of a patrol. The device (1) also comprises a calculation module (12) comprising at least one artificial intelligence algorithm (120) configured to calculate the optimal itinerary, according to configurable decision criteria stored in memory, based on data stored in a database. The calculation module (12) may also comprise an event detection sub-module (121) configured to be able to access, via the Internet (3), different networks, in particular social networks, or other sources of public or private information to detect planned and unplanned events, and to collect data from the detected events. It may subsequently record said collected data in the database (11) of the device (1) in order to improve the management and optimization of the itineraries by the calculation module (12) which then has more data. The device (1) sends the result of the calculations of the calculation module (12), corresponding to at least one created itinerary (5, FIG. 2), to the communication terminal (2) via the respective communication modules (13, 23) thereof. The device (1) and the terminal (2) may each comprise an encryption and decryption sub-module (130, 230) to encrypt and decrypt the communication and thus make it possible to improve the security and confidentiality of the data exchanges. The communication terminal (2) records the data received in its database (21). An application (20) comprising a graphic display module (200) makes it possible to display the data received, for example in the form of an itinerary (5) or graphical order (Z) on a screen (not shown). A module for calculating the position of the terminal (22) enables the terminal (2) to calculate, to display on a screen, and to send the data of its position to the device (1). Additionally, a module for the manual input of data enables a user to input data into the application (20), the data being able for example to be sent to the management device (1) for updating the database (11) thereof, for example regarding an unplanned event, and recalculating an itinerary by the calculation module (12) of the device (1).

More particularly, FIG. 2 shows examples of displays of itineraries (5) according to non-limiting embodiments of the present invention (FIGS. 2A, 2B and 2C). In FIG. 2A, the graphic display module (200) of the application (20) displays several itineraries (5a, 5b, 5c) calculated by the calculation module (12) of the management device (1). Points of interest (6) are visible and information associated with a point of interest (7) is displayed upon a request from a user. In FIG. 2B, the map is segmented into zones to be monitored (8), the graphic display module (200) being able to display information associated with a zone (8). The information displayed in FIGS. 2A and 2B may be georeferenced (70) and/or non-georeferenced information. FIG. 2C is another type of display produced by the graphic display module (200) of the application (20) on a screen of a communication terminal (2), which comprises the position of the terminal (9) calculated by the module for calculating the position of the terminal (22) an itinerary (5) georeferenced information (70) a point of interest (6) and passing points (60).

The information regarding events and people carrying out the itineraries are stored in a database of the device, then analyzed by said artificial intelligence algorithm of the calculation module to calculate an itinerary. The majority of the information is georeferenced, for example events referenced by their latitude and longitude, such as a protest, an attack or another point of interest. Cartographic information can also be georeferenced, such as roads or a bridge.

Conversely, some information may not be georeferenced, such as the age of the patrol member, or the number of patrols they have carried out. In some embodiments, the calculated itinerary is in the form of a sequence of georeferenced points. The GIS, Geographic Information System (latitude and longitude data), can be used in the device.

In some embodiments, at least one server is dedicated to searching and detecting planned events, for example a national celebration, and unplanned events, for example a trade union meeting, an attack, a strike or a gathering. Information published on the Internet, information from administrative centers or public services, regarding authorized gatherings of people, weather warnings, police or fire services, are recovered by said server and analyzed in order to detect events with the aim of calculating an itinerary which goes through these events or comes close to them, this parameter preferably being defined by the person skilled in the art (such as the user or operator who configures the system). In some embodiments, it is also possible to modify the itinerary in real time, including when the patrol is already following said itinerary, as long as the geographical coordinates of the patrol are known, preferably by virtue of a communication terminal carried by at least one of the members of said patrol. The route may be modified, or the patrol may be informed of the nearby event in order for it to intervene (intervention request) without modifying the itinerary. In some embodiments, the intervention request is carried out via the communication terminal.

In some embodiments, the database comprises examples of typical events, with which are associated a security or presence action, or a maximum distance of the location of the event relative to at least one itinerary calculated by the calculation module. In the case in which the calculation module detects an event, the distance of which relative to each calculated itinerary is greater than a threshold, the module can modify the itinerary of a patrol to reduce the route distance to beneath this threshold.

In some embodiments, the calculation module can estimate the criticality of an event, preferably in an automated manner, for example on a criterion of number of people affected by the event, in order to weight the importance of each event and prioritize certain thereof. Advantageously, this makes it possible, when several nearby events each representing hazards are detected, to modify the itinerary in order to incorporate at least some of these events into the itinerary and thus to prioritize the patrolling of some of these events which are considered to be critical.

In some embodiments, the database comprises data relating to each person, for example, each soldier, in particular the distance covered, the number of patrols carried out, the age, the type of regiment, the grade, the equipment and/or vehicles, or any other information which may have an influence on the calculation of the itinerary. This advantageously makes it possible to balance out the efforts of each person or group of people, and to optimize the patrols based on each person's profile.

In some embodiments, the number of patrols carried out by each person is stored in the database, the calculation module being able to use this data as a decision factor for the choice of the participants in an itinerary. Likewise, it is possible to configure the calculation module in order for the same person not to carry out an itinerary in a given zone too many times. For example, the calculation module may take into account the number of interventions carried out by a person or a patrol over a given zone, may compare this number to a predetermined threshold and assign another patrol to said zone if the threshold (e.g. an intervention quota) is exceeded.

In some embodiments, the calculation module performs statistical studies on each coverage zone, the statistical studies relating inter alia to the number of coverage itineraries carried out in a given zone, how many geographical points, and when. The calculation module subsequently performs a comparison of each zone compared to other zones in order to weight the results of said studies. Associated with other factors described in the application, this enables the calculation module to calculate an itinerary to be carried out, and preferentially to calculate and suggest people to carry out said itinerary, among the people available for patrolling. Thus, if several itineraries have been carried out in the same zone, the calculation module may assign a patrol to another zone and/or to another route, in particular in real time, in order to balance the coverage of the zones of a region.

In some embodiments, the calculation module produces coverage maps, for example illustrated in a non-limiting manner in FIG. 2B, from lists of planned and/or unplanned events, the events being manually or automatically georeferenced. Each event can be weighted, in particular based on the criticality thereof, and each available factor is weighted and used to perform the itinerary calculation.

In some embodiments, unplanned events are searched for on different sources, such as information channels and sites, for example by “text mining” or automated search in the text, are georeferenced, and weighted, for example based on the criticality thereof. It is further possible to weight a particular zone, for example to concentrate on the critical, significant or on the other hand benign nature thereof.

The route optimizations may be carried out by different optimization algorithms: traveling salesman algorithm, which is renowned and simple, or other more statistical and more complex algorithms, such as Dijkstra's algorithm.

“Occupation” preferences can be added to influence the route, based for example on the patrol. Thus, in the presence of a regiment of mountain soldiers, and a regiment of marines, it is preferable for the mountain regiment to carry out the itinerary comprising hills or mountains which it will be necessary to climb. Likewise, a transport regiment is useful for covering large zones, based on the means of transport, for example in a train or in a vehicle. Information on equipment of groups of soldiers may also influence the calculation of the itinerary and the choice of soldiers. For example, a group equipped with amphibious vehicles will be favored for patrols in a swampy zone. Each occupation preference thus represents a factor to be weighted based on the situations, in order to decide which itinerary for which group of people.

In some embodiments, it is possible to manually or automatically add “waypoints”, or checkpoints or passing points, through which the patrol must pass, for example points of interest (POIs), events considered to be sensitive, etc. Some of these points may be basic and fixed, for example linked to the topography of the zone, such as a bottleneck, for example a bridge to be crossed. Others are not events but required passing points, such as churches, mosques, refugee commissions. The passing points may for example be cartographic or contextual points or points representing sensitive sites.

At-risk zones are determined based on the number of sensitive sites and planned or unplanned events in the zone, both current and past events. Past events are thus stored in a history in a database, and said events may be associated with a degree of criticality which may be taken as a weighting factor during the calculation of the itinerary to be carried out.

In some embodiments, the relevance of the patrol members is an item of information making it possible to influence the choice of the personnel for a given itinerary. The patrol members may generate unplanned events on their communication terminal. Some generate more of them than others. In some embodiments, it will be considered that a good patrol member generates a large number of unplanned events (based on the criticality of the zone to be patrolled). In other embodiments, it is possible to calculate a score of relevance to this event creation based on several factors, for example the number of events created, the studies thereof, the criticality of the zone to be patrolled. Patrol members having a high score may for example be assigned to a high-criticality zone.

The device, and the system for managing itineraries processes a large amount of data in order to perform, preferably in real time, the calculation of itineraries for different groups of people. This data processing may for example be carried out in steps, each batch of data being processed by an algorithm.

It will be readily apparent from reading the present application that the particular features of the present invention, as generally described and illustrated in the figures, can be arranged and designed in a wide variety of different configurations. Thus, the description of the present invention and the figures relating thereto are not intended to limit the scope of the invention but merely represent selected embodiments.

A person skilled in the art will understand that the technical features of a given embodiment may in fact be combined with features of another embodiment unless the opposite is explicitly mentioned or it is obvious that these features are incompatible. In addition, the technical features described in a given embodiment may be isolated from the other features of this embodiment unless the opposite is explicitly stated.

It must be obvious to those skilled in the art that the present invention enables embodiments in numerous other specific forms without departing from the field defined by the scope of the appended claims; they must be considered as illustrative and the invention must not be limited to the details given above.

### LIST OF REFERENCE SIGNS

1. Itinerary management device
11. database
12. calculation module
120. Artificial intelligence algorithm(s)
121. event detection sub-module
13. communication module
130. encryption and decryption sub-module
2. Communication terminal
20. application
200. graphic display module
201. manual data input module
21. database
22. terminal position calculation module
23. communication module
230. decryption sub-module
3. Internet
4. Itinerary management system
5, 5a, 5b, 5c. Itineraries
6. Point of interest
60. Passing points
7. Information associated with a point of interest
70. Georeferenced information
8. Zone to be monitored
9 Position of the terminal
Z. Displayed itinerary

1. A device for managing itineraries for a group of people,
comprising program modules executable on one or more processing hardware components such as a microprocessor, wherein the device comprises:
a module for communicating data in real time, able to send and receive data from at least one other communication module, the data comprising for example information relating to planned or unplanned events,
at least one database comprising vectorial and/or georeferenced geographical data, and non-georeferenced data,
a module for calculating an itinerary to be carried out, the calculation module calculating said itinerary based on information transmitted by the reception module, the module for calculating an itinerary implementing at least one artificial intelligence algorithm configured to calculate the optimal itinerary, according to configurable decision criteria stored in memory, based on data stored in a database, said artificial intelligence algorithm being based on data, preferentially ranked data, from the database, such as stored public and private data comprising itineraries, events, and past situations, and/or present and past weather or news data.

2. The device according to claim 1, wherein the database comprises vectorial and/or georeferenced geographical data, and non-georeferenced data, the data comprising information relating to events, the topography surrounding at least one terminal used by a member of the group and/or the group, or even information relating to the group.

3. The device according to claim 1, wherein the calculation module comprises an event detection sub-module configured to be able to access, via the Internet, different networks, in particular social networks, or other sources of public or private information to detect planned and unplanned events, to collect data from the detected events, and to record them in the database of the device, for example by extraction and analysis of public or private data such as those originating from social networks or messages.

4. The device according to claim 1, said calculation module is configured to automatically rank said detected events according to criteria defined in relation to a mission of the group of people.

5. The device according to claim 1, wherein the configurable decision criteria make it possible to add constraints for the calculation of the itinerary, for example preferences, passing points or checkpoints, information originating from a database relating to the personnel and in particular the state of each member of the personnel constituting, or who may constitute, the group, or complementary orders originating from a hierarchical level, for example bans.

6. The device according to claim 1, wherein the data received and sent by the device is encrypted, the device further comprising an encryption and decryption module to decrypt the data received and to encrypt the data sent.

7. The device according to claim 1, wherein the calculation module provides the itinerary in the form of a graphical command or a map, comprising colored dots or symbols, for example connected to one another, which indicate on the graphic or the map particular places or events.

8. The device according to claim 1, wherein the calculation module is configured to send and order the display of different types of information and mission orders.

9. The device according to claim 1, wherein the data used by the calculation module is extracted from private databases containing same, and selected from private data such as the past routes of patrols in order to determine the duration of the patrol based on the perimeter to be covered, past events noted and recorded in the communication system, sensitive sites stored in memory and located within the patrol's perimeter, the relevance of the patrol members based on data from the personnel database, the number of kilometers already covered by the personnel of the group provided by the terminal of at least one member of the group, the topography of the ground provided by vectorial geographical databases, and public data such as weather or for example the current state of planned or unpredicted events, this data being recovered by an interface connected to the Internet, or specific databases.

10. The device according to claim 1, wherein the detection sub-module is configured to perform textual and/or contextual analyses to detect planned and/or unplanned events.

11. An itinerary management system comprising the device for managing itineraries of a group of people according to claim 1, the system further comprising a communication terminal, preferably a mobile communication terminal carried by at least one user forming part of said group of people, the communication terminal comprising:
a module for communicating data in real time, able to send and receive data from at least one other communication module, the data comprising for example information relating to planned or unplanned events,
a man-machine interface (MMI) application comprising a graphic display module for the itinerary calculated by the calculation module, configured to display on said communication terminal said itinerary and/or information received from the device,
at least one database comprising vectorial and/or georeferenced geographical data, and non-georeferenced data, the data comprising, for example, information relating to events, the topography surrounding at least one terminal used by a member of the group and/or the group, and data relating to the group.

12. The system according to claim 11, wherein the application of the terminal further comprises a module for the manual input of data or events, for example of unplanned events, by the user of the terminal, the communication terminal preferably being configured to send said data or event to the itinerary management device.

13. The system according to claim 11, wherein the terminal further comprises a module for calculating the position of said terminal, configured to calculate in real time the position of a user of the device via their terminal and, for example, locate them on their route or even orient a map relative to the position, orientation and/or movement of the user.

14. The system according to claim 13, wherein the module for calculating the position of said terminal is configured to send said position of the terminal to the itinerary management device, by sending data via the communication module of the terminal.

15. The system according to claim 11, wherein the graphic display module provides the itinerary in the form of a graphical command or a map, comprising colored dots or symbols, for example connected to one another, which indicate on the graphic or the map particular places or events.

16. The system according to claim 11, wherein the graphic display module is configured to display different types of information and mission orders.

17. The system according to claim 11, each communication module comprises an encryption module configured to encrypt data to be sent via the communication module and to decrypt encrypted data received by the communication module.

18. The system according to claim 11, the system further comprising a secure communication server configured to be a relay gateway between the itinerary management device and a plurality of communication terminals, the server comprising a communication module configured to send data of the calculated itinerary to a plurality of communication modules of a plurality of terminals, and an encryption and decryption module configured to encrypt data to be sent to the device and to the terminal and to decrypt encrypted data received from the device and from the terminal.
